(19) United States
(12) Patent Application Publication
(10) Pub. No.: US 2005/0051278 A1
(43) Pub. Date: Mar. 10, 2005

(54) Apparatus and method for applying tape to wall board

(76) Inventor: Michael L. Dobson, Porter, TX (US)

Correspondence Address: STREETS & STEELE, 13831 NORTHWEST FREEWAY, SUITE 355, HOUSTON, TX, 77040, US

(21) Appl. No.: 10/657,885

(22) Filed: Sep. 9, 2003

(51) Int. Cl. B32B 31/00; B44C 7/00

(52) U.S. Cl. 156/579; 156/574; 156/510

(57) ABSTRACT

An apparatus adapted for applying a material from a roll to a surface, such as tape to a seam formed by abutting edges of adjacent wall board sheets, includes a frame for rotatably supporting the roll of material at a location remote from a user. The frame has an opening though which material may be dispensed from the roll, and a roller is carried by the frame adjacent the opening for pressing material dispensed through the opening from the rotatably-supported roll against a desired surface. A brake is also supported by the frame for applying a braking force to the rotatably-supported roll of material, thereby preventing material from being dispensed through the opening from the roll as desired. An elongated handle is also connected to the frame, and an actuator is connected to the elongated handle opposite the frame for remotely actuating the brake. In one embodiment, the apparatus further includes a cutting member, also actuated by the actuator, having a cutting edge for cutting material dispensed through the opening from the rotatably-supported roll.

### BACKGROUND OF THE INVENTION

1. Field of the Invention

The present invention relates generally to devices for applying material from a roll to a surface, and more particularly to devices for applying tape from a roll to seams between adjacent sheets of wall board.

2. Background of the Related Art

The interior walls and ceilings of buildings, whether commercial, residential, or otherwise, are commonly covered and/or formed of a plurality of wall boards. Such wall board includes a central layer of relatively hard gypsum material and is covered on each face by one or more layers of heavy paper. Wall board is otherwise known in the construction art as sheetrock, drywall, and gypsum board. Once the walls of a building are framed with studs, sheets of wall board are affixed or “hung” to the studs such that the edges of adjacent sheets on a wall are abutting in coplanar fashion and the edges of adjacent sheets at a wall/ceiling corner are abutting in a perpendicular arrangement. The line formed by the abutting edges, often called a seam, groove, or joint, is typically filled with a gypsum-based compound, allowed to set, and then sanded to affect a smooth, continuous appearance.

The filling of the seams between sheets of wall board will usually involve the use of “tape” to give body to the seam and reduce the amount of gypsum compound required to fill the seam. Such tape is typically paper-based and, in most instances, includes a pressure-sensitive adhesive coating on one side of the tape. It is also common for the tape to have a screen-like texture to which the gypsum compound can readily adhere.

The tape is purchased from a construction supplier in a ready-to-use roll, whether plain paper, mesh, or adhesive-backed, and appropriate lengths are dispensed from the roll and applied to wall board joints or seams. The application of tape over long seams can be awkward, messy, and difficult to accomplish. In particular, it is often difficult to apply uniform pressure to an elongated tape length to promote the desired smooth finish. A need therefore exists for a tape applicator that is easy to load, manipulate, and apply varying lengths of tape to a variety of wall and ceiling configurations.

A number of tape applicators have been described and claimed in various, related U.S. patents. For example, U.S. Pat. No. 3,880,701 to Moree discloses an applicator having an elongated frame for dispensing tape from a tape roll and applying a mud compound from a reservoir to the tape as it is dispensed. A cutting knife is actuated by a slide member forward of the tape roll for severing the tape at desired lengths. A braking mechanism stops the tape from being dispensed, and is actuated by the same means that actuates the cutting knife, but the brake applies a normal braking force to the tape thereby frustrating the use of adhesive backed tape. The applicator is equipped with a short handle that limits the user's range of motion, requiring that a user be assisted with stilts, a ladder, and/or scaffolding to apply tape to elevated seams on a wall or ceiling.

U.S. Pat. No. 3,960,643 to Dargitz et al. also provides the dual utility of tape and compound application to wall board seams. The disclosed device is also limited by a relatively short handle, and the compound application makes the device somewhat cumbersome. A pull-handle actuates a cutting blade, but no brake is applied to assist in the cutting process.

U.S. Pat. No. 4,196,028 to Mills et al. disclosed another fairly cumbersome device that provides for the application of tape and compound to wall board seams, including corner seams. A sliding control member forward of the tape roll actuates a cutting blade, but no braking mechanism is provided to assist in cutting desired tape lengths.

U.S. Pat. No. 4,406,730 to Altmix describes a compact, hand-held device that has no extension handle whatsoever. The device is useful for flat and corner seams between adjacent sheets of wall board. A hand-operated lever actuates a cutting blade to sever a length of tape. No braking means is supplied.

U.S. Pat. No. 4,452,663 to Heaton discloses another relatively compact device for applying tape and compound to wall board seams. The applicator is equipped with a trigger-actuated brake that applies a normal braking force to the dispensed tape. No integrated cutting mechanism is included.

U.S. Pat. No. 4,555,298 to Boucher discloses a relatively simple tape actuator that includes a cutting blade biased towards a cutting position, and released from a retracted position by a trigger actuator. Reliable tape cutting will require the user to pivot the device. The device further lacks a brake assembly to assist in tape cutting.

U.S. Pat. No. 4,707,202 to Sweeny discloses a device that's particularly adapted for taping of corner seams. The device is equipped with a relatively short handle and a trigger-actuated cutting blade for obtaining desired tape lengths. No brake assembly is disclosed.

U.S. Pat. No. 4,913,766 to Lojdstrom describes a tape applicator having a tape cutting blade actuated by a push-rod assembly. The device lacks a brake assembly for the tape being dispensed.

It is therefore desirable to provide a tape applicator that overcomes the above-described shortcomings in the relevant art. More particularly, it is desirable to provide an applicator that is relatively simple to construct and use, that is useful over a wide range of motion without elevation aids for the user, and that includes a braking mechanism that complements the cutting mechanism. It is further desirable to provide such an applicator wherein the braking and cutting mechanisms are actuated at a distance remote from the region at which tape is applied to a seam, thereby facilitating the desired wide range of motion.

### SUMMARY OF THE INVENTION

The present invention is embodied in an apparatus adapted for applying a material from a roll to a surface, and includes a frame for rotatably supporting a roll of material. The frame has an opening though which material may be dispensed from the roll. A roller is carried by the frame adjacent the opening for pressing material dispensed through the opening from the rotatably-supported roll against a desired surface. A brake is also supported by the frame for applying a braking force to the rotatably-supported roll of material, thereby preventing material from being dispensed through the opening from the roll as desired. An elongated handle is also connected to the frame for dispensing material to a relatively remote surface. An actuator is connected to the elongated handle opposite the frame for remotely actuating the brake.

In a presently preferred embodiment, the inventive apparatus further includes a cutting member having a cutting edge. The cutting member is carried by the frame adjacent the opening for cutting material dispensed through the opening from the rotatably-supported roll. It is further preferred that the cutting member be pivotally mounted to the frame for rotation of the cutting edge into engagement with material dispensed through the opening from the roll.

The roll of material is preferably rotatably-supported by a shaft carried by the frame, and the frame preferably includes substantially parallel side walls defining a space within which the shaft and material roll are carried. The space defines a pathway for material to move from the rotatably-supported roll to the opening for dispensing.

It is further preferred that the frame include a lip adjacent the opening that is yieldably biased towards the roller for assuring at least a portion of material fed to the opening from the roll rotatably supported by the frame remains at the opening.

It is further preferred that the brake of the apparatus applies a braking force to a side of the roll of material rotatably supported by the frame. This will permit the use of adhesive-backed material rolls, unlike braking mechanisms that apply a normal force to the dispensed material.

It is further preferred that the elongated handle of the inventive apparatus be connected to the frame at one of its ends and be connected to the actuator adjacent the other of its ends, permitting a user to apply material via the frame to a relatively remote surface. The actuator preferably comprises a lever pivotally connected to the elongated handle opposite the frame and a linkage connecting the lever to the brake. The elongated handle of this preferred embodiment is tubular and the linkage includes an elongated link connected to the lever and extending through at least a substantial portion of the elongated handle. The elongated link may include any one of a rod, a bar, or a cable, or other equivalent structure.

It is further preferred that the actuator provide the function of remotely rotating the cutting edge into engagement with material dispensed through the opening from the roll rotatably supported by the frame. In this embodiment, the actuator comprises a lever pivotally connected to the elongated handle opposite the frame and a linkage connecting the lever to the brake and the cutting member.

In accordance with the preferred application of the inventive apparatus, the material may be tape, such as paper tape, meshed tape, and/or adhesive-backed tape, for application to a particular surface: the seams between abutting sheets of wall board.

The present invention is further embodied in a method of applying material from a roll to a surface, including the step of loading a roll of material into a dispensing frame mounted on an elongated handle and having an opening and a pressing roller. An end of the material is fed from the roll through the frame opening, and the end of the material is pressed against the surface using the handle and the pressing roller. The handle and pressing roller are further used to move the frame along the surface and dispense the material from the roll through the frame opening and apply the material over the surface. A braking force is remotely applied to the material roll from a location on the handle opposite the frame to prevent material from being dispensed from the roll.

It is preferred that the method further include the step of remotely applying a cutting force to the material adjacent the opening from a location on the handle opposite the frame to separate the material applied to the surface from the frame.

In accordance with the preferred application of the inventive method, the material is tape and the surface is a seam between abutting sheets of wall board.

### BRIEF DESCRIPTION OF THE DRAWINGS

So that the above recited features and advantages of the present invention can be understood in detail, a more particular description of the invention is provided by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an apparatus adapted for applying a material from a roll (e.g., tape from a tape roll) to a surface (e.g., over the seam formed between abutting sheets of wall board) in accordance with the present invention;

FIG. 2 is a detailed view, in cross-section, of a frame according to the present inventive apparatus for rotatably supporting a roll of material such as tape at a remote distance from a user; and

FIGS. 3-5 are sequential views of the inventive apparatus being used to apply tape to a seam formed between two abutting sheets of wall board.

### DETAILED DESCRIPTION OF THE INVENTION

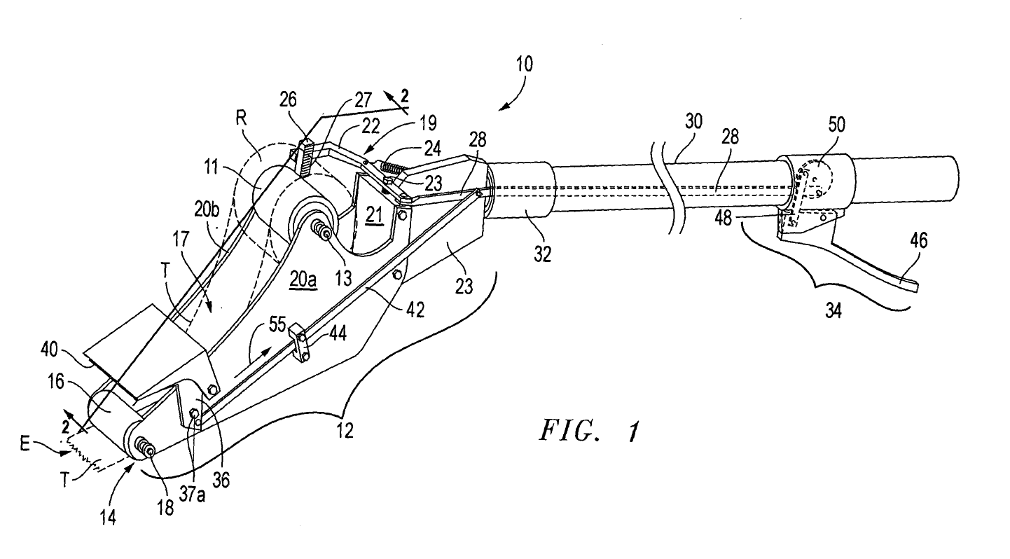

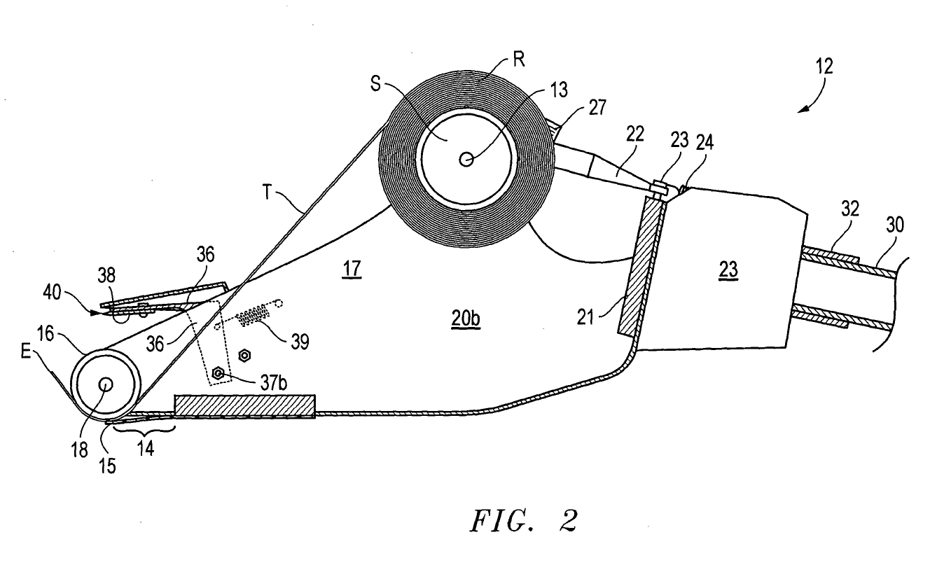

FIGS. 1-2 illustrate a preferred embodiment of the present invention in the form of an apparatus 10 adapted for applying a material from a roll to a surface, especially for applying tape T from a tape roll R to seams formed by abutting sheets of wall board. The invention is adaptive for the various types of tape used for such wall board applications, including paper tape, meshed tape, and adhesive-backed tape The apparatus 10 includes a frame 12 for rotatably supporting the roll R by way of a quick-release shaft 13 rotatably supported between the walls 20a, 20b of the frame 12, and a spool 11 between the shaft 13 and the tape roll R. The side walls 20a, 20b are substantially parallel and define a space 17 between the walls within which the shaft 13 and roller R are carried. The space 17 also defines a pathway for the tape T to move from the roll R to an opening 14 in the frame 12 for dispensing. Those skilled in the art will appreciate that the design of the frame 12 facilitates easy loading and unloading of various types of tape rolls R (as described further below).

A roller 16 is carried by the frame 12 adjacent the opening 14 by way of a pin 18 rotatably supported between the side walls 20a, 20b of the frame 12. The roller 16 serves to press the tape T dispensed through the opening 14 from the roll R against a desired surface, as described further below. The frame 12 further include a lip 15 (see FIG. 2) adjacent the opening 14 that is yieldably biased towards the roller 16 for assuring at least a portion of the tape T fed to the opening 14 from the roll R remains at the opening after the tape has been fed through the opening.

A brake 19 is also supported by the frame 12 for applying a braking force to the tape roll R, thereby preventing tape T from being dispensed through the opening 14 from the roll R as desirable. The brake 19 includes a caliper 22 pivotally mounted to a cross-plate 21 of the frame 12 via a pin 23. The caliper 22 is urged to an open position (shown in FIG. 1) by spring 24 connected at one of its ends (not shown) to the frame 12. One end of the caliper 22 carries a brake pad 26 having a frictional surface 27 for frictionally engaging the side of tape roll R when the caliper is actuated to its closed position. The other end of the caliper 22 is connected to an elongated link 28 that is operable to actuate the brake 19 (described further below), whereby a braking force is applied to the side of the roll R rotatably supported by the frame 12. This side-braking aspect of the apparatus 10 permits the use of adhesive-backed tape rolls, unlike braking mechanisms that apply a normal force to the dispensed tape.

An elongated tubular handle 30 is also connected to the frame 12 by way of a tubular sleeve 32. The tubular sleeve 32 is affixed to one end of the handle 30 by conventional means such as adhesive or set screws. The tubular sleeve 32 is also affixed to the rear plate 23 of the frame 12 by way of bolted or welded connection (not shown). The handle 30 is preferably no shorter than three feet in length so as to facilitate placement of the frame 12 adjacent a surface remote from the user, making the inventive apparatus 10 useful over a wide range of motion without requiring mobility aids for the user. The invention further contemplates the handle having an adjustable length, such as a telescoping design whose length is “set” using (an alternative version of) sleeve 32.

In keeping with the desired characteristics of light weight and durability, substantially all of the apparatus 10 may be constructed of aluminum or a light gauge stainless steel. Alternatively, portions of the apparatus may be constructed of a plastic material such as polyvinyl chloride.

The inventive apparatus 10 further includes a cutting member 36 carrying a cutting blade 38 (see FIG. 2) having a cutting edge 40. The cutting member 36 is carried by the frame 12 adjacent the opening 14 for cutting tape T dispensed through the opening 14 from the rotatably-supported roll R. The cutting member 36 is pivotally mounted to the side walls 20a, 20b of the frame 12 via pins 37a, 37b for rotation of the cutting edge 40 into engagement with the tape T dispensed through the opening 14. The cutting member is normally biased to a retracted position by a spring 39 connected at one of its ends to the side wall 20ab of the frame 12.

Rotation of the cutting member 36 against this bias is induced by a pulling force delivered to the cutting member adjacent pin 37a (see FIG. 1) by a cutting link 42 pivotally connected at one of its ends to the cutting member 36. The cutting link 42 passes through a C-shaped guide 44 connected to the side wall 20a for constraining the cutting link to movement in a substantially linear path. The end of the cutting link 42 opposite the cutting member 36 is pivotally connected to the elongated link 28, which is operable to pull the cutting link 42 in the direction of the arrow 55 shown in FIG. 1.

An actuator 34 is connected to the elongated handle 30 opposite the frame 12 for remotely actuating the brake 19 and the cutting member 36. The actuator preferably comprises a hand lever 46 pivotally connected to the elongated handle 30, and normally opened to the position shown in FIG. 1. The hand lever 46 is operatively connected to the elongated link 28 by way of crank 48 and wheel 50, and the pivotal pinned connections between these components, as indicated in FIG. 1. Those skilled in the art will appreciate that numerous other means for translating the pivoting action of hand lever 46 into (substantially) linear motion of elongated link 28 may be employed with equivalent utility. The elongated link 28 extends through at least a substantial portion of the tubular elongated handle 30, and may be a rod, a bar, or a cable, or other equivalent structure.

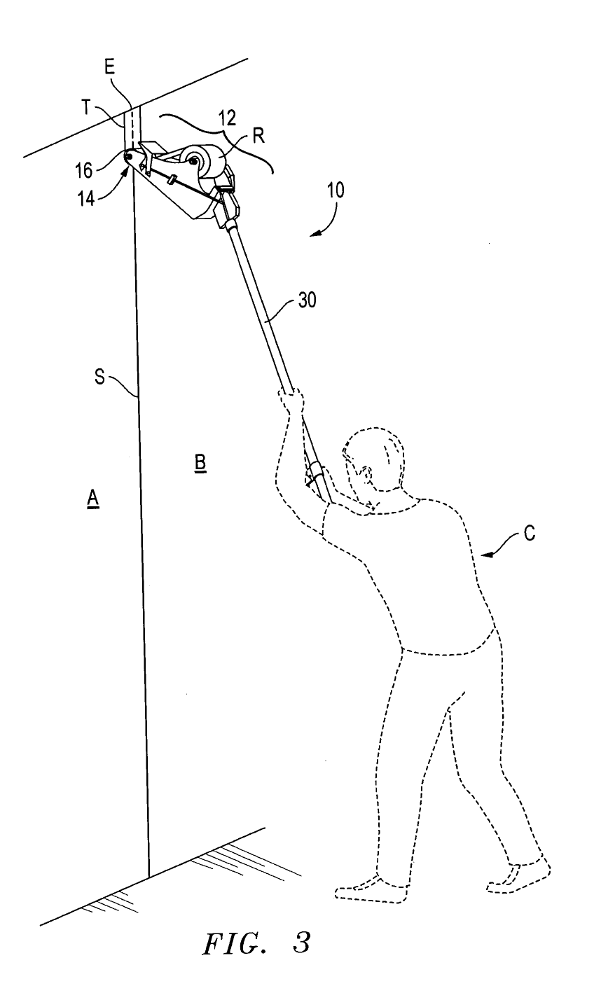

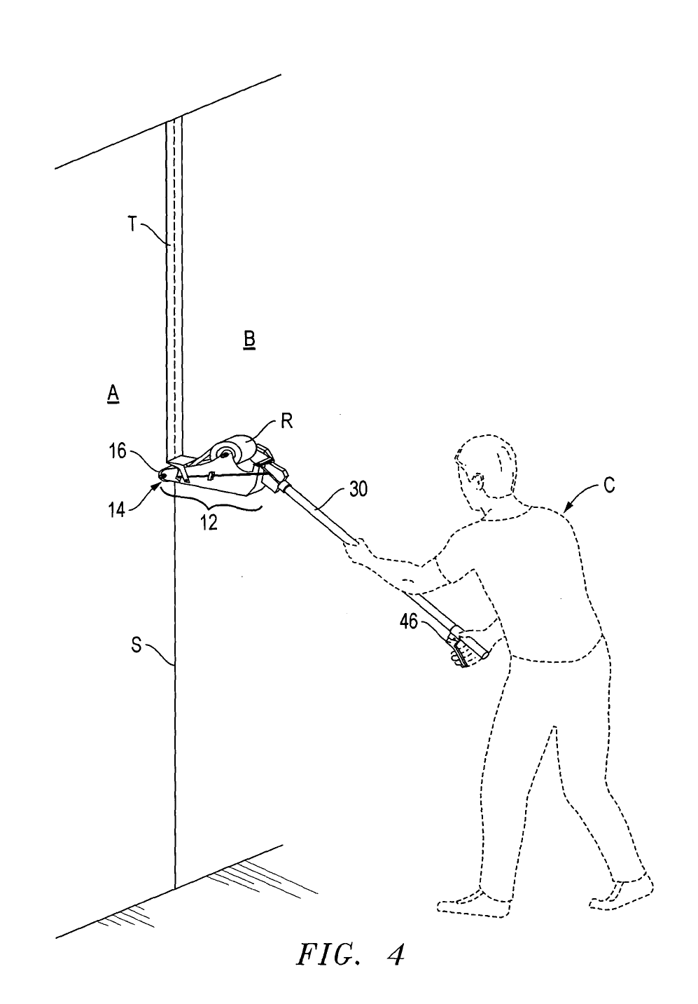

Referring now to FIGS. 1-5, the operation of the inventive apparatus 10 will now be described. First, a tape roll R is loaded into the dispensing frame 12 by removing the quick-release shaft 13 and spool 11, loading the roll R onto the spool 11, and securing the loaded spool 11 within the frame space 17 using the shaft 13. An end E of the tape T is then fed from the roll R through the frame opening 14, whereby the apparatus 10 is ready to use. A taping operation begins by pressing the end E of the tape against a starting surface, such as the upper region of a seam S between abutting sheets A, B of wall board (see FIG. 3), by a user C using the handle 30 and the pressing roller 16. The frame 12 is then moved downwardly along the wall board surfaces adjacent the seam S using the handle 30 and pressing roller 16, whereby the tape T frictionally engages the seam-defining surfaces and is dispensed from the roll R through the frame opening 14. In this manner (see also FIG. 4), the tape T may be applied to the wall board surfaces defining the seam S over substantially the entire length of the seam from ceiling to floor.

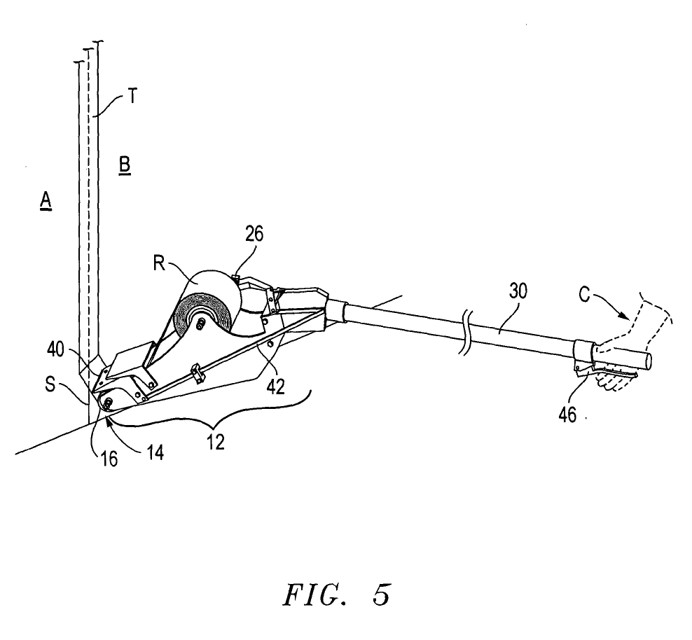

When the frame 12 has been lowered by the user C to a position adjacent the floor (see FIG. 5), a braking force is remotely applied to the tape roll R from a location on the handle 30 opposite the frame 12, preventing the tape T from being further dispensed from the roll. In other words, the user C pulls the hand lever 46 of the actuator 34 to induce movement of caliper 22 via elongated link 28 that closes frictional surface 27 of the brake pad 26 upon the side of the tape roll R. This prevents further dispensing of the tape T through the opening 14 in the frame 12, effectively preventing the user C from rolling the roller 16 any further down the surface of the seam S.

The actuation of the elongated link 28 by the hand lever 46 also actuates cutting link 42 to apply a cutting force to the tape T adjacent the frame opening 14. This causes the cutting edge 40 to engage and cut the tape T, separating the tape applied over the seam S from the frame 12. A gypsum compound may then be applied over the tape and finished to affect a smooth, continuous appearance.

It will be understood from the foregoing description that various modifications and changes may be made in the preferred and alternative embodiments of the present invention without departing from its true spirit. This description is intended for purposes of illustration only and should not be construed in a limiting sense. The scope of this invention should be determined only by the language of the claims that follow.

1. An apparatus for applying a material from a roll to a surface, comprising:
a frame for rotatably supporting a roll of material, the frame having an opening though which material may be dispensed from the roll;
a roller carried by the frame adjacent the opening for pressing material dispensed through the opening from a roll rotatably supported by the frame against a surface;
a brake supported by the frame for applying a braking force to a roll of material rotatably supported by the frame, thereby preventing material from being dispensed through the opening from the roll;
an elongated handle connected to the frame; and
an actuator connected to the elongated handle for remotely actuating the brake.

2. The apparatus of claim 1, further comprising a cutting member having a cutting edge, the cutting member being carried by the frame adjacent the opening for cutting material dispensed through the opening from a roll rotatably supported by the frame.

3. The apparatus of claim 2, wherein the cutting member is pivotally mounted to the frame for rotation of the cutting edge into engagement with material dispensed through the opening from a roll rotatably supported by the frame.

4. The apparatus of claim 1, further comprising a shaft carried by the frame for rotatably supporting a roll of material.

5. The apparatus of claim 4, wherein the frame includes substantially parallel side walls defining a space within which the shaft and roll are carried.

6. The apparatus of claim 5, wherein the space defines a pathway for material to move from a roll rotatably supported by the frame to the opening for dispensing.

7. The apparatus of claim 1, wherein the frame includes a lip adjacent the opening that is yieldably biased towards the roller for assuring at least a portion of material fed to the opening from a roll rotatably supported by the frame remains at the opening.

8. The apparatus of claim 1, wherein the brake applies a braking force to a side of a roll of material rotatably supported by the frame.

9. The actuator of claim 1, wherein the elongated handle is connected to the frame at one of its ends and is connected to the actuator adjacent another of its ends.

10. The apparatus of claim 1, wherein the actuator comprises a lever pivotally connected to the elongated handle opposite the frame and a linkage connecting the lever to the brake.

11. The apparatus of claim 10, wherein the elongated handle is tubular and the linkage includes an elongated link connected to the lever and extending through at least a substantial portion of the elongated handle.

12. The apparatus of claim 11, wherein the elongated link comprises one of a rod, a bar, and a cable.

13. The apparatus of claim 3, wherein the actuator is also connected to the elongated handle for remotely rotating the cutting edge into engagement with material dispensed through the opening from a roll rotatably supported by the frame.

14. The apparatus of claim 13, wherein the actuator comprises a lever pivotally connected to the elongated handle opposite the frame and a linkage connecting the lever to the brake and the cutting member.

15. An apparatus for applying tape from a roll to a seam between abutting sheets of wall board, comprising:
a frame for rotatably supporting a roll of tape, the frame having an opening though which tape may be dispensed from the roll;
a roller carried by the frame adjacent the opening for pressing tape dispensed through the opening from a roll rotatably supported by the frame against a seam between abutting sheets of wall board;
a brake supported by the frame for applying a braking force to a roll of tape rotatably supported by the frame, thereby preventing tape from being dispensed through the opening from the roll;
an elongated handle connected to the frame; and
an actuator connected to the elongated handle for remotely actuating the brake.

16. The apparatus of claim 15, further comprising a cutting member having a cutting edge, the cutting member being carried by the frame adjacent the opening for cutting tape dispensed through the opening from a roll rotatably supported by the frame.

17. The apparatus of claim 16, wherein the cutting member is pivotally mounted to the frame for rotation of the cutting edge into engagement with tape dispensed through the opening from a roll rotatably supported by the frame.

18. The apparatus of claim 15, further comprising a shaft carried by the frame for rotatably supporting a roll of tape.

19. The apparatus of claim 18, wherein the frame includes substantially parallel side walls defining a space within which the shaft and roll are carried.

20. The apparatus of claim 19, wherein the space defines a pathway for tape to move from a roll rotatably supported by the frame to the opening for dispensing.

21. The apparatus of claim 15, wherein the frame includes a lip adjacent the opening that is yieldably biased towards the roller for assuring at least a portion of tape fed to the opening from a roll rotatably supported by the frame remains at the opening.

22. The apparatus of claim 15, wherein the, brake applies a braking force to a side of a roll of tape rotatably supported by the frame.

23. The actuator of claim 15, wherein the elongated handle is connected to the frame at one of its ends and is connected to the actuator adjacent another of its ends.

24. The apparatus of claim 15, wherein the actuator comprises a lever pivotally connected to the elongated handle opposite the frame and a linkage connecting the lever to the brake.

25. The apparatus of claim 24, wherein the elongated handle is tubular and the linkage includes an elongated link connected to the lever and extending through at least a substantial portion of the elongated handle.

26. The apparatus of claim 25, wherein the elongated link comprises one of a rod, a bar, and a cable.

27. The apparatus of claim 17, wherein the actuator is also connected to the elongated handle for remotely rotating the cutting edge into engagement with tape dispensed through the opening from a roll rotatably supported by the frame.

28. The apparatus of claim 27, wherein the actuator comprises a lever pivotally connected to the elongated handle opposite the frame and a linkage connecting the lever to the brake and the cutting member.

29. A method of applying material from a roll to a surface, comprising the steps of:
loading a roll of material into a dispensing frame mounted on an elongated handle and having an opening and a pressing roller;
feeding an end of the material from the roll through the frame opening; using the handle and the pressing roller, pressing the end of the material against the surface;
using the handle and pressing roller, moving the frame along the surface to dispense the material from the roll through the frame opening and apply the material over the surface;
remotely applying a braking force to the material roll from a location on the handle opposite the frame to prevent material from being dispensed from the roll.

30. The method of claim 29, further comprising the step of remotely applying a cutting force to the material adjacent the opening from a location on the handle opposite the frame to separate the material applied to the surface from the frame.

31. The method of claim 29, wherein the material is tape and the surface is a seam between abutting sheets of wall board.
